(19) United States
(12) Patent Application Publication
(10) Pub. No.: US 2021/0029209 A1
(43) Pub. Date: Jan. 28, 2021

(54) METHOD, DEVICE, TERMINAL, SERVER, SYSTEM AND STORAGE MEDIUM FOR DISPLAYING INFORMATION

(71) Applicant: Beijing Dajia Internet Information Technology Co., Ltd., Beijing (CN)

(72) Inventor: Yang Zhang, Beijing (CN)

(21) Appl. No.: 17/070,740

(22) Filed: Oct. 14, 2020

(30) Foreign Application Priority Data
Oct. 16, 2019 (CN) 201910983559.3

(51) Int. Cl. H04L 29/08; H04L 29/06; G06F 3/14

(52) U.S. Cl. CPC H04L 67/26; H04L 67/42; G06F 3/14; H04L 67/32; H04L 65/60

(57) ABSTRACT

The embodiments of the disclosure can provide a method, device, terminal, server, system and storage medium for displaying information. The method applied to a terminal includes: receiving a triggering operation for a notification message and acquiring first data of a target interface corresponding to the notification message, where the notification message is for notifying target information with an invalidation condition, and the target information is no longer displayed after meeting the invalidation condition; acquiring an original parameter of the target information from a server when the first data does not include the target information; and reorganizing the target information based on the original parameters, and displaying the target information in the target interface.

### CROSS-REFERENCE TO RELATED APPLICATION

This application is based on and claims priority under 35 U.S.C 119 to Chinese Patent Application No. 201910983559.3, filed on Oct. 16, 2019, in the China National Intellectual Property Administration. The entire disclosure of the above application is incorporated herein by reference.

### FIELD

The present disclosure relates to the technical field of network information processing, in particular to a method, device, terminal, server, system and storage medium for displaying information.

### BACKGROUND

In live streaming rooms and other network platforms, there is often some information with invalidation conditions, such as red envelopes, shared messages, etc. These information becomes invalid after the invalid conditions are met, and then a terminal will no longer display the information when it enters a live streaming interface. A red envelope is taken as an example, when the red envelope is sent for a certain period of time, or when the whole red envelope is grabbed, the red envelope becomes invalid information.

For this information with invalidation conditions, before the information becomes invalid, in order to notify users of entering corresponding interfaces to process the information, a server may send a notification message to a terminal. For example, the server may send a notification message to the terminal to notify the users of entering the live streaming rooms to grab red envelopes. Since different notification channels are different in message triggering speed and the users see the notification message at different times, when the users enter the corresponding interfaces according to the notification message, the information with the invalidation conditions may have become invalid, and the terminal will no longer display the information at this time. Therefore, the users may not find the information when entering the corresponding interfaces according to the notification message to process the information with the invalidation conditions.

### SUMMARY

The embodiments of the present disclosure provide a method, device, terminal, server, system and storage medium for displaying information.

According to some embodiments of the present disclosure, a method for displaying information applied to a terminal is provided, and the method includes:
receiving a triggering operation for a notification message; where the notification message is for notifying target information with an invalidation condition, and the target information is no longer displayed after meeting the invalidation condition;
acquiring first data of a target interface corresponding to the notification message;
acquiring an original parameter of the target information from a server when the first data does not comprise the target information;
reorganizing the target information based on the original parameter; and
displaying the target information in the target interface.

In one embodiment, the original parameters include at least a source and content information of the target information; and the reorganizing the target information based on the original parameter and displaying the target information in the target interface includes:
determining a target display style corresponding to the target information according to the source, the content information and a preset corresponding relationship, where the preset corresponding relationship is a corresponding relationship between the source and the content information and a preset display style; and
displaying the target information at a preset position in the target interface according to the target display style.

In one embodiment, the target interface is an interface for displaying multimedia data streams; and the displaying the target information in the target interface includes:
displaying the target information by inserting the target information into the multimedia data streams presented at the target interface.

In one embodiment, the method further includes:
acquiring an invalidation cause of the target information; and
displaying prompt information corresponding to the invalidation cause in response to a triggering operation for the target information.

In one embodiment, the notification message includes a message identifier of the target information; and the acquiring the original parameter of the target information from the server includes:
sending a request for acquiring the original parameter to the server, where the request includes at least the message identifier; and
receiving the original parameter corresponding to the message identifier from the server.

According to some embodiments of the present disclosure, a method for displaying information applied to a server is provided, and the method includes:
receiving a request for acquiring an original parameter from a terminal; where the terminal is configured to reorganize target information based on the original parameter, and display the target information in a target interface;
determining the original parameter corresponding to the request; and
sending the original parameter to the terminal.

In one embodiment, the method further includes:
determining an invalidation cause of the target information; and
sending the invalidation cause to the terminal.

In one embodiment, before receiving the request for acquiring the original parameter from the terminal, the method further includes:
sending a notification message about the target information to the terminal.

In one embodiment, the notification message includes a message identifier of the target information; and the receiving the request for acquiring the original parameter from the terminal, and determining the original parameter corresponding to the request includes:
receiving the request for acquiring the original parameter from the terminal, where the request includes at least the message identifier; and
determining the original parameter corresponding to the message identifier.

According to some embodiments of the present disclosure, a device for displaying information applied to a terminal is provided, and the device includes:
a data acquiring module, configured to receive a triggering operation for a notification message; where the notification message is for notifying target information with an invalidation condition, and the target information is no longer displayed after meeting the invalidation condition; and acquire first data of a target interface corresponding to the notification message;
an original parameter receiving module, configured to acquire an original parameter of the target information from a server when the first data does not include the target information; and
a target information reorganizing module, configured to reorganize the target information based on the original parameter and display the target information in the target interface.

In one embodiment, the original parameter include at least a source and content information of the target information; and
the target information reorganizing module includes:
a display style determining unit, configured to determine a target display style corresponding to the target information according to the source, the content information and a preset corresponding relationship, where the corresponding relationship is a corresponding relationship between the source and the content information and a preset display style; and
a first target information display unit, configured to display the target information at a preset position in the target interface according to the target display style.

In one embodiment, the target interface is an interface for displaying multimedia data streams; and
the target information reorganizing module includes:
a second target information display unit, configured to display the target information by inserting the target information into the multimedia data streams presented at the target interface.

In one embodiment, the device further includes:
an invalidation cause acquisition module, configured to acquire an invalidation cause of the target information; and
a prompt information display module, configured to display prompt information corresponding to the invalidation cause in response to the triggering operation for the target information.

In one embodiment, the notification message includes a message identifier of the target information; and
the original parameter receiving module includes:
an identifier sending unit, configured to send a request for acquiring the original parameter to the server, where the request includes at least the message identifier; and
an original parameter receiving unit, configured to receive the original parameter corresponding to the message identifier from the server.

According to some embodiments of the present disclosure, a device for displaying information applied to a server is provided, and the device includes:
an original parameter determining module, configured to receive a request for acquiring an original parameter from a terminal; where the terminal is configured to reorganize target information based on the original parameter, and display the target information in a target interface; and determine the original parameter corresponding to the request; and
an original parameter sending module, configured to send the original parameter to the terminal.

In one embodiment, the device further includes:
an invalidation cause determining module, configured to determine an invalidation cause of the target information; and
an invalidation cause sending module, configured to send the invalidation cause to the terminal.

In one embodiment, the device further includes:
a notification message sending module, configured to send a notification message about the target information to the terminal before receiving the request for acquiring the original parameter from the terminal.

In one embodiment, the notification message includes a message identifier of the target information; and
the original parameter determining module includes:
an acquisition request receiving unit, configured to receive the request for acquiring the original parameter from the terminal, where the request includes at least the message identifier; and
an original parameter determining unit, configured to determine the original parameter corresponding to the message identifier.

According to some embodiments of the present disclosure, a terminal is provided and includes:
a processor; and
a memory for storing instructions, and the instructions enable the processor to execute the instructions;
where the processor is configured to execute the instructions to implement any one of the above methods for displaying information applied to a terminal.

According to some embodiments of the present disclosure, a server is provided and includes:
a processor; and
a memory for storing instructions, and the instructions enable the processor to execute the instructions;
where the processor is configured to execute the instructions to implement any one of the above methods for displaying information applied to a server.

According to some embodiments of the present disclosure, a system for displaying information is provided and includes: the above terminal and server.

According to some embodiments of the present disclosure, a storage medium is provided. When instructions in the storage medium are executed by a processor of electronic equipment, the electronic equipment implements any one of the above methods for displaying information applied to a terminal.

According to some embodiments of the present disclosure, a storage medium is provided. When instructions in the storage medium are executed by a processor of electronic equipment, the electronic equipment implements any one of the above methods for displaying information applied to a server.

### BRIEF DESCRIPTION OF THE DRAWINGS

The accompany drawings herein are incorporated into the Description and constitute a part of the Description, show embodiments conforming to the present disclosure, are used to explain the principle of the present disclosure together with the Description, and do not constitute an improper limitation of the present disclosure.

FIG. 1 is a flowchart of a first method for displaying information according to an exemplary embodiment;

FIG. 2 is a specific flowchart of S103 in FIG. 1 according to an exemplary embodiment;

FIG. 3 is a flowchart of a method for displaying prompt information according to an exemplary embodiment;

FIG. 4 is a flowchart of a second method for displaying information according to an exemplary embodiment;

FIG. 5 is a flowchart of a method for determining the cause of invalidation according to an exemplary embodiment;

FIG. 6 is a structural block diagram of a system for displaying information according to an exemplary embodiment;

FIG. 7 is a signaling interaction diagram in a system for displaying information according to an exemplary embodiment;

FIG. 8 is a structural block diagram of a first device according to an exemplary embodiment;

FIG. 9 is a structural block diagram of a second device according to an exemplary embodiment;

FIG. 10 is a structural block diagram of a terminal according to an exemplary embodiment;

FIG. 11 is a block diagram of a specific structure of a terminal according to an exemplary embodiment;

FIG. 12 is a structural block diagram of a server according to an exemplary embodiment; and

FIG. 13 is a block diagram of a specific structure of a server according to an exemplary embodiment.

### DETAILED DESCRIPTION OF THE EMBODIMENTS

In order to enable those of ordinary skill in the art to better understand the technical solutions of the present disclosure, the technical solutions in the embodiments of the present disclosure are described clearly and completely in conjunction with the accompanying drawings below.

It should be noted that the terms such as “first” and “second” in the Description and claims of the present disclosure and the above-mentioned accompanying drawings are used to distinguish similar objects, rather than being used to describe a specific order or sequence. It should be understood that the terms used in this way can be interchanged under appropriate circumstances so that the embodiments of the present disclosure described herein can be implemented in a sequence other than those illustrated or described herein. The implementation modes described in the following exemplary embodiments do not represent all implementation modes consistent with the present disclosure, on the contrary, these are merely examples of devices and methods consistent with some aspects of the present disclosure as detailed in the appended claims.

In order to make the target information visible to a user when entering target interfaces according to notification messages, regardless of whether the target information has become invalid, embodiments of the present disclosure provide a method, device, terminal, server, system and storage medium for displaying information.

A first method for displaying information provided by the embodiments of the present disclosure will be introduced at first below. The first method for displaying information provided by the embodiments of the present disclosure can be applied to a terminal. The terminal may be installed with a live streaming application.

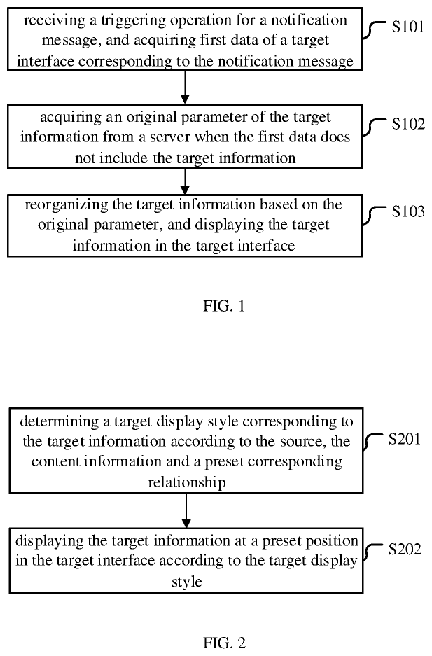

As shown in FIG. 1, an information display method includes as follows.

S101, receiving a triggering operation for a notification message, and acquiring current data of a target interface corresponding to the notification message.

The notification message is for notifying target information with invalidation conditions, the target information is no longer displayed after meeting the invalidation conditions, and the invalidation conditions may be set according to specific application scenarios or application requirements.

S102, acquiring an original parameter of the target information from a server when the current data does not include the target information.

S103, reorganizing the target information based on the original parameter, and displaying the target information in the target interface.

It can be seen that in the solution provided by the embodiment of the present disclosure, the terminal can receive the triggering operation for the notification message and acquire the current data of the target interface corresponding to the notification message. The notification message is for notifying target information with the invalidation conditions, and the target information is no longer displayed after meeting the invalidation conditions. When the current data does not include the target information, the original parameter of the target information is acquired from the server, the target information is reorganized based on the original parameter, and the reorganized target information is displayed in the target interface. In this way, a user can see the target information when entering the target interface according to the notification message, regardless of whether the target information has become invalid.

In some embodiments, when target information with an invalidation condition appears on a network platform such as a live streaming room, a terminal displays a notification message to notify the user that there currently exists target information that can be processed. The notification message is a notification message about the target information with the invalidation condition for notification of the target information with the invalidation conditions. Target information is no longer displayed once it satisfies the invalidation condition.

After seeing the notification message, the user performs a triggering operation such as clicking on the notification message. In the above S101, when the terminal receives the triggering operation for the notification message, since the interface corresponding to the notification message, namely the target interface needs to be displayed then, the terminal can acquire the current data of the target interface.

The notification message is a message including link information of a web page, and the foregoing notification message includes link information of the target interface so as to perform a triggering operation such as clicking on the notification message. When the terminal acquires the triggering operation for the notification message, in some embodiments, the acquired current data of the target interface is HTML (HyperText Markup Language) webpage data of the target interface, and includes interface content currently displayed in the target interface.

When the user sends the above triggering operation for the notification message, the target information may be in two states, and that is, the target information meets the invalidation conditions or does not meet the invalidation conditions. When the target information meets the invalidation conditions, the target information is no longer displayed in the interface, therefore, in order to determine whether the target information at the current moment meets the invalidation condition, the terminal can determine whether the current data include the target information.

If the current data of the target interface include the target information, it means that the target information is displayed in the target interface, then the target information does not meet the invalidation conditions, and at this time, the target interface displayed by the terminal includes the target information, which can be viewed by the user.

If the current data of the target interface does not include the target information, it means that the target information is not displayed in the target interface, and the target information meets the invalidation condition and has become invalid information, then in order to enable the user to see the target information when entering the target interface, the terminal can get the original parameter of the target information from the server, i.e., execute the above step S102.

In one embodiment, the terminal can send an identifier of the target information or a data request and the like to the server. After receiving the identifier of the target information or the data request, the server can determine original data corresponding to the identifier or the data request and send the original data to the terminal. That is the terminal can receive original parameters, sent by the server, of the target information.

The original parameters are parameters of the target message generation, which may include the information type, an identifier of the information sender, specific information content and the like. For example, if the target information is a red envelope in a live streaming room, the original parameters may include an identifier of the red envelope sender, the amount of the red envelope, the time for sending out the red envelope and the like.

In the S103, the terminal can reorganize the target information based on the foregoing original parameters. In other words, the terminal can regenerate the target information according to the original parameters of the target information. For example, if the target information is a red envelope in a live streaming room, the terminal can regenerate a red envelope according to the original parameters such as an identifier of the red envelope, the amount of the red envelope and the time for sending out the red envelope.

After reorganizing the target information, the terminal can display the reorganized target information in the above-mentioned target interface. In this way, the user can see the target information in the target interface, and even if the target information notified by the notification message becomes invalid, the target information can still be restored and supplied to the user. Meanwhile, the authenticity of the notification message can be effectively guaranteed, and the user experience can be improved.

For example, if the target interface corresponding to the notification message is a live streaming room interface A and the reorganized target information is a red envelope, the terminal can display the live streaming room interface A, in which the interface shows the reorganized red envelope, and thus the user can see the red envelope displayed in the live streaming room interface A.

The aforementioned invalidation conditions may include a preset duration condition and a preset value condition. The preset duration condition is that the target information becomes invalid information after a certain period of time since the target information is generated, and the preset value condition is that the target information corresponds to a certain value and the target information becomes invalid information when the value is invalid. For example, for target information of a red envelope type, when the red envelope is issued for a certain period of time, or when the amount of the red envelope has been taken, the red envelope becomes invalid. Therefore, there may be many causes for invalidation of the target information.

In one embodiment, the aforementioned original parameter includes at least a source and content information of the target information. The source of the target information is sender information of the target information, which may be an identifier of the sender. For example, in a live streaming interface, the source of target information of the red envelope type may be an anchor, audiences, guests and system.

The content information of the target information is information related to the specific content of the target information, in some embodiments, the content information may include related information such as the issue time point, the invalidation time point and the type of the target information. For example, in the live streaming interface, the content information of target information of the red envelope type may include the amount, the issue time point, the invalidation time point, the type of the red envelope and the like.

In this case, as shown in FIG. 2, the foregoing step of reorganizing the target information based on the original parameter and displaying the target information in the target interface may include as follows.

S201, determining a target display style corresponding to the target information according to the source, the content information and a preset corresponding relationship.

The corresponding relationship may be the relationship between the source and the content information and a preset display style. Since display styles of target information with different sources and content information may generally be different, in order to facilitate the determination of the target display style corresponding to the target information, the terminal can preset the corresponding relationship, and thus the terminal can determine the target display style corresponding to the target information according to the source and the content information of the target information and the preset corresponding relationship after obtaining the original parameter of the target information.

The display style may include styles in different aspects such as display colors, patterns and motion effects, etc., which is not specifically limited herein.

Taking the target information as the red envelope and the content information as the amount of the red envelope as an example, the preset corresponding relationship may be shown in the following table:

TABLE 1

| Source | Amount | Display style |
|---|---|---|
| Anchor | <S1 | Style a1 |
| | S1-S2 | Style a2 |
| | >S2 | Style a3 |
| Audience | <S3 | Style b1 |
| | S3-S4 | Style b2 |
| | >S4 | Style b3 |
| System | <S5 | Style c1 |
| | S5-S6 | Style c2 |
| | >S6 | Style c3 |

If the source of the original parameters obtained by the terminal is an anchor and the amount is S1-S2, then the terminal can determine that the target display style corresponding to the target information is Style a2 according to the corresponding relationship in the above table.

S202, displaying the target information at a preset position in the target interface according to the target display style.

After the target display style of the target information is determined, the terminal can display the target information at the preset position in the target interface according to the target display style. The preset position may be any position in the target interface, which is not specifically limited herein.

For example, for target information of a red envelope type, in order to attract attention of users and highlight the target information, the preset position may be the center of the target interface.

Thus, when the original parameter includes at least the source and the content information of the target information, the terminal can determine the target display style corresponding to the target information according to the source, the content information and the preset corresponding relationship, and then display the target information at the preset position in the target interface according to the target display style. In this way, the target information can be accurately displayed in the target interface.

In one embodiment, the above-mentioned target interface may be an interface for presenting multimedia data streams. For example, the target interface may be a live streaming interface, a short video presentation interface, an image presentation interface, a news presentation interface and the like.

In this embodiment, the above step of displaying the target information in the target interface may include: displaying the target information by inserting the target information into multimedia data streams presented at the target interface.

In one embodiment, when the target interface is an interface of which the content is updated in real time such as a live streaming interface, the terminal can insert the target information for display while presenting live streaming content at the live streaming interface. Since the live streaming content is updated in real time, floating windows, masks, etc. can be adopted to display the target information in order not to affect the display of the live content.

In another embodiment, when the target interface is an interface that will not be updated in real time, such as a short video presentation interface, an image presentation interface or a news presentation interface, the terminal can insert the reorganized target information for display while presenting short video content at the short video presentation interface. The terminal can display the target information by means of floating windows, masks and the like, or display the target information in a way of covering original interface content.

Thus, when the target interface is the interface for presenting the multimedia data streams, the terminal can insert the reorganized target information into the multimedia data streams presented in the target interface for display so that a user can see the reorganized target information.

In one embodiment, the foregoing method for displaying information may further include: acquiring an invalidation cause of the target information; and displaying prompt information corresponding to the invalidation cause in response to the triggering operation for the target information.

While acquiring the original parameter of the target information from the server, the terminal can also acquire the invalidation cause of the target information from the server. That is, in addition to determining the foregoing original parameter, the server can also determine the invalidation cause of the target information, and send the invalidation cause to the terminal together with the original parameter.

Accordingly, after the above step of displaying the target information in the target interface, the above method may further include: displaying prompt information corresponding to the invalidation cause in response to the triggering operation for the target information.

After the terminal displays the target information in the target interface, the user can perform a triggering operation such as clicking on the target information, at this time, the terminal can acquire the triggering operation for the target information from the user. The triggering operation indicates that the user wants to process the target information.

In order to remind the user that the target information has met the invalidation condition and becomes invalid information at this time, the terminal can display the prompt information according to the invalidation cause of the target information.

When it is determined that the invalidation cause of the target information is due to expiration, it means that the target information has been sent for a long time and reached a preset duration. At this time, the terminal can display prompt information indicating that the target information has expired to inform the user. For example, for the target information of a red envelope type, the terminal may display the prompt information “The red envelope has expired”.

When it is determined that the invalidation cause of the target information is zero value, it means that the invalidation cause of the target information is that the value is no longer valid. At this time, the terminal can display prompt information indicating that the value of the target information is insufficient to inform the user. For example, for the target information of a red envelope type, the terminal may display the prompt information “The whole red envelope has been grabbed”.

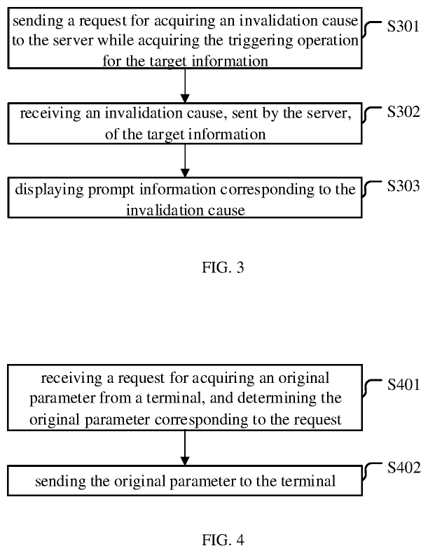

In one embodiment, as shown in FIG. 3, after the above step of displaying the target information in the target interface, the above method may further include as follows.

S301, sending a request for acquiring an invalidation cause to the server while acquiring the triggering operation for the target information.

S302, receiving an invalidation cause, sent by the server, of the target information.

After the terminal displays the target information in the target interface, when the user performs a triggering operation such as clicking on the target information, it indicates that the user wants to process the target information. At this time, the terminal can send the request for acquiring the invalidation cause to the server, where the request for acquiring the invalidation cause may include the identifier of the target information.

After receiving the identifier, sent by the terminal, of the target information, the server can determine the invalidation cause of the target information, and send the invalidation cause to the terminal. Thus, the terminal can receive the invalidation cause of the target information from the server.

S303, displaying prompt information corresponding to the invalidation cause.

Since the implementation mode of S303 has been introduced in the previous embodiment, reference may be made to the description of the corresponding part in the previous embodiment, which is not to be described in detail herein.

Thus, the terminal can acquire the invalidation cause of the target information, and display the prompt information corresponding to the invalidation cause in response to the triggering operation for the target information. When the target information is in different invalid states, the user can be informed of the invalidation cause of the target information.

In one embodiment, before the step of receiving the triggering operation for the notification message and acquiring the current data of the target interface corresponding to the notification message, the above method may further include as follows.

The terminal receives the notification message sent by the server; and continuously displays the notification message until it receives a triggering operation for the notification message.

When the target information with the invalidation conditions is displayed on a network platform such as a live streaming room, the server of the network platform can generate the notification message about the target information, and send the notification message to the terminal. The terminal can then receive the notification message sent by the server and display the notification message.

When the terminal displays the above notification message, if the terminal obtains the triggering operation for the notification message, the terminal can execute the above information processing method; and when the terminal does not obtain the triggering operation for the notification message, in order to enable the user to view the notification message, the terminal can continuously display the notification message until the triggering operation for the notification message is received.

Thus, the terminal can receive the notification message sent by the server, and continuously display the notification message until the triggering operation for the notification message is received. In this way, it can be ensured that the user can view the notification message.

In one embodiment, the above notification message may include a message identifier of the target information.

Accordingly, the foregoing step of acquiring the original parameter of the target information from the server may include: sending a request for acquiring the original parameter to the server, and receiving the original parameter corresponding to the message identifier from the server.

In order to facilitate the acquisition of the original parameters from the server by the terminal when the original parameters of the target information are needed, the notification message about the target information generated by the server may include the message identifier of the target information. In this way, when the terminal determines that the current data of the target interface do not include the target information, the terminal can send a request for acquiring the original parameter to the server. The request for acquiring the original parameter includes at least the message identifier of the target information.

In this way, after receiving the request for acquiring the original parameter, the server can determine the original parameters corresponding to the message identifier and send the original parameters to the terminal. The terminal can also receive the original parameters which are sent by the server and correspond to the message identifier.

Thus, the above notification message may include the message identifier of the target information. In this way, when the terminal determines that the current data of the target interface do not include the target information, the terminal can send the request for acquiring the original parameter to the server, and the terminal can conveniently acquire the original parameters of the target information from the server.

Corresponding to the above-mentioned first method for displaying information, an embodiment of the present disclosure further provides another method for displaying information. The second method for displaying information provided by the embodiment of the present disclosure will be introduced below.

The second method for displaying information provided by the embodiment of the present disclosure can be applied to a server. When the above-mentioned first method for displaying information is used to process related information of a live streaming application, the server may be a server of the live streaming application.

As shown in FIG. 4, a method for displaying information applied to a server, includes as follows.

S401, receiving a request for acquiring an original parameter from a terminal, and determining the original parameter corresponding to the request.

S402, sending the original parameter to the terminal.

The terminal is configured to reorganize target information based on the original parameter, and display the target information in a target interface.

Thus, the server can receive the request for acquiring the original parameter sent by the terminal, determine the original parameter corresponding to the request, and send the original parameter to the terminal. Then, the terminal can reorganize the target information based on the original parameter and display the reorganized target information in the target interface. Thus, when a user enters the target interface according to a notification message, even if the target information notified by the notification message becomes invalid, the target information can still be restored and supplied to the user, so that the user experience is improved.

For example, when the target information with invalidation conditions is displayed on a network platform such as a live streaming room, the terminal can display the notification message to notify the user that there currently exists the target information can be processed, and the user can perform a triggering operation such as clicking on the notification message after seeing the notification message. When the terminal obtains the triggering operation for the notification message, the terminal can acquire current data of the target interface, and then determine whether the current data include the target information.

If the current data of the target interface do not include the target information, it means that the target information is not displayed in the target interface, and the target information has become invalid information, then in order to enable the user to see the target information when entering the target interface, the terminal can send the request for acquiring the original parameter to the server, and further, in the step S401, the server can receive the request for acquiring the original parameter sent by the terminal. After receiving the request for acquiring the original parameter, the server can determine the original parameters corresponding to the request.

Then, the server can send the original parameters to the terminal, that is, execute the step S402. The terminal can receive the original parameters then and regenerate the target information according to the original parameters of the target information. Furthermore, the above-mentioned target interface is displayed, and the reorganized target information is displayed in the target interface. In this way, the user can see the target information in the target interface, even if the target information notified by the notification message becomes invalid, the target information can still be restored and supplied to the user, so that the user experience is improved.

In one embodiment, the method for displaying information applied to the server may further include: determining the invalidation cause of the target information; and sending the invalidation cause to the terminal.

In one embodiment, before sending the original parameters to the terminal, the method for displaying information applied to the server may further include: determining the invalidation cause of the target information.

When the target information meets the invalidation conditions, the server can record information related to the invalidation conditions met by the target information as the invalidation cause of the target information. In this way, after the server receives the request for acquiring the original parameter sent by the terminal, in addition to determining the original parameters, the server can also determine the invalidation cause of the target information.

Accordingly, while sending the original parameters to the terminal, the server can also send the invalidation cause to the terminal.

While sending the original parameters to the terminal, the server can also send the determined invalidation cause to the terminal. In this way, the terminal can determine the invalidation conditions met by the target information according to the invalidation cause of the target information, and then display corresponding prompt information.

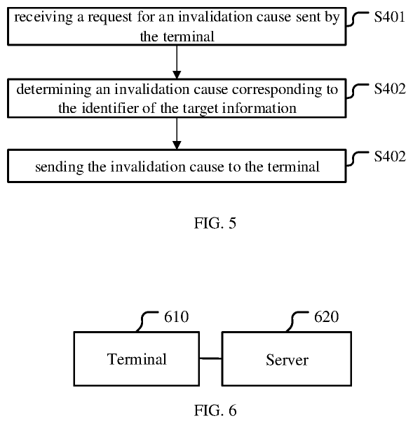

In one embodiment as shown in FIG. 5, after sending the original parameters to the terminal, the method for displaying information applied to the server may further include as follows.

S501, receiving a request for an invalidation cause sent by the terminal.

After the terminal displays the target information in the target interface, when the user performs a triggering operation such as clicking on the target information, it indicates that the user wants to process the target information. At this time, the terminal can send the request for acquiring the invalidation cause to the server, and the request includes an identifier of the target information, and then the server can receive the request including the identifier of the target information from the terminal.

S502, determining an invalidation cause corresponding to the identifier of the target information.

S503, sending the invalidation cause to the terminal.

After receiving the request for acquiring the invalidation cause from the terminal, the server can determine the invalidation cause corresponding to the identifier of the target information. Then, by sending the invalidation cause to the terminal, the terminal can determine the invalidation conditions met by the target information according to the invalidation cause of the target information, and then display the corresponding prompt information.

Thus, the server can determine the invalidation cause of the target information and send the invalidation cause to the terminal. In this way, the terminal can determine the invalidation conditions met by the target information according to the invalidation cause of the target information, and then display the corresponding prompt information.

In one embodiment, before receiving the request for acquiring the original parameter from the terminal, the method for displaying information applied to the server may further include: sending a notification message to the terminal.

The notification message is a notification message about the target information. When the target information with the invalidation conditions is displayed on a network platform such as a live streaming room, the server can generate the notification message about the target information, and send the notification message to the terminal. The terminal can then receive the notification message sent by the server and display the notification message. The notification message may be sent to the terminal in the form such as pushed information, short messages and emails.

Thus, the server can send the notification message to the terminal. In this way, the terminal can display the notification message to notify the user that there currently exists target information that can be processed to facilitate user's operation.

In one embodiment, the above notification message may include a message identifier of the target information. In this case, the step of receiving the request for acquiring the original parameter sent by the terminal and determining the original parameter corresponding to the request for acquiring the original parameter may include: receiving the request for acquiring the original parameter from the terminal, and determining the original parameter corresponding to the message identifier.

The request for acquiring the original parameter sent by the terminal may include at least the message identifier, and the message identifier is the message identifier included in the notification message. In order to facilitate the determination of the original parameters corresponding to the message identifier of the target information sent by the terminal, the server can record the corresponding relationship between the original parameter of the each target information and the message identifier of the each target information. Then, the server can determine the original parameter corresponding to the message identifier of the target information based on the corresponding relationship.

Thus, when the notification message includes the message identifier of the target information, the server can receive the request for acquiring the original parameter sent by the terminal, and then determine the original parameter corresponding to the message identifier. In this way, the server can quickly and accurately determine the original parameters corresponding to the target information.

Corresponding to the foregoing methods for displaying information, an embodiment of the present disclosure further provides a system for displaying information.

As shown in FIG. 6, the system for displaying information may include a terminal 610 and a server 620. The terminal 610 is configured to perform the steps of the first method for displaying information described in any of the foregoing embodiments, and the server 620 is configured to perform the steps of the second method for displaying information described in any of the foregoing embodiments.

Thus, the terminal can receive a triggering operation for a notification message and acquire current data of a target interface corresponding to the notification message; when the current data does not include target information notified by the notification message, a request for acquiring an original parameter is sent to the server, the server can determine an original parameter corresponding to the request for acquiring the original parameter and send the original parameter to the terminal, and then the terminal can reorganize the target information based on the original parameter and display the reorganized target information in the target interface, so that when a user enters the target interface according to the notification message, even if the target information notified by the notification message becomes invalid, the target information can still be restored and supplied to the user, so that the user experience is improved.

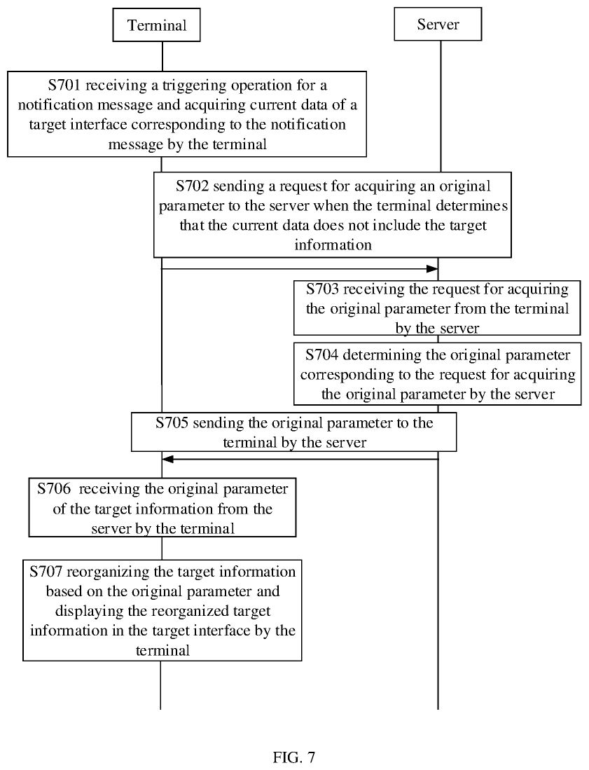

In order to further describe the system for displaying information provided by the embodiment of the present disclosure, the interaction process between the terminal and the server in the system for displaying information provided by the embodiment of the present disclosure will be introduced below in conjunction with FIG. 7. As shown in FIG. 7, the interaction process between the terminal and the server in the information display system provided by the embodiment of the present disclosure may include as follows.

S701, receiving a triggering operation for a notification message and acquiring current data of a target interface corresponding to the notification message by the terminal.

The notification message is for notifying target information with an invalidation condition, and the target information is not displayed after meeting the invalidation condition.

S702, sending a request for acquiring an original parameter to the server when the terminal determines that the current data does not include the target information.

S703, receiving the request for acquiring the original parameter from the terminal by the server.

S704, determining the original parameter corresponding to the request for acquiring the original parameter by the server.

S705, sending the original parameter to the terminal by the server.

S706, receiving the original parameter of the target information from the server by the terminal.

S707, reorganizing the target information based on the original parameter and displaying the reorganized target information in the target interface by the terminal.

Since the implementation modes of S701 to S707 have been introduced in the foregoing embodiments, the specific implementation modes are not described in detail herein.

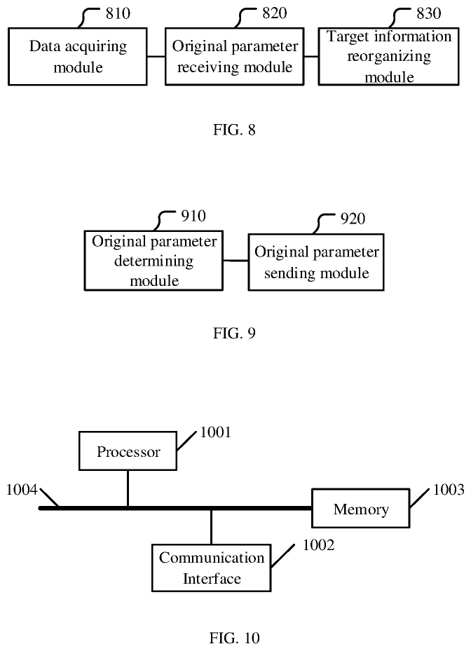

FIG. 8 is a block diagram of a first device for displaying information according to an exemplary embodiment.

As shown in FIG. 8, the device for displaying information is applied to a terminal, and the device includes:
a data acquiring module 810, configured to receive a triggering operation for a notification message; where the notification message is for notifying target information with an invalidation condition, and the target information is no longer displayed after meeting the invalidation condition; and acquire current data of a target interface corresponding to the notification message;
an original parameter receiving module 820, configured to acquire an original parameter of the target information from a server when the current data does not include the target information; and
a target information reorganizing module 830, configured to reorganize the target information based on the original parameter and display the target information in the target interface.

Thus, the terminal can receive the triggering operation for the notification message, acquire the current data of the target interface corresponding to the notification message and acquire the original parameter of the target information from the server to reorganize the target information and display the target information in the target interface when the current data does not include the target information notified by the notification message, so that when a user enters the target interface according to the notification message, even if the target information notified by the notification message becomes invalid, the target information can still be restored and supplied to the user, so that the user experience is improved.

In one embodiment, the foregoing original parameter may include at least a source and content information of the target information;

The aforementioned target information reorganizing module 830 may include:
a display style determining unit (not shown in FIG. 8), configured to determine a target display style corresponding to the target information according to the source, the content information and a preset corresponding relationship, where the corresponding relationship is a corresponding relationship between the source and the content information and a preset display style, and
a first target information display unit (not shown in FIG. 8), configured to display the target information at a preset position in the target interface according to the target display style.

In one embodiment, the abovementioned target interface may be an interface for displaying multimedia data streams;
the aforementioned target information reorganizing module 830 may include:
a second target information display unit (not shown in FIG. 8), configured to display the target information by inserting the target information into the multimedia data streams presented at the target interface.

In one embodiment, the foregoing device may further include:
an invalidation cause acquisition module (not shown in FIG. 8), configured to acquire an invalidation cause of the target information; and
a prompt information display module (not shown in FIG. 8), configured to display prompt information corresponding to the invalidation cause in response to the triggering operation for the target information.

In one embodiment, the above notification message may include a message identifier of the target information;
the foregoing original parameter receiving module 820 may include:
an identifier sending unit (not shown in FIG. 8), configured to send a request for acquiring the original parameter to the server, where the request includes at least the message identifier, and
an original parameter receiving unit (not shown in FIG. 8), configured to receive the original parameter corresponding to the message identifier from the server.

FIG. 9 is a block diagram showing a second device for displaying information according to an exemplary embodiment.

As shown in FIG. 9, the device for displaying information is applied to a server, and the device includes:
an original parameter determining module 910, configured to receive a request for acquiring an original parameter from a terminal, and determine the original parameter corresponding to the request; and
an original parameter sending module 920, configured to send the original parameter to the terminal;
where the terminal is configured to reorganize target information based on the original parameter, and display the target information in a target interface.

Thus, the server can receive a request for acquiring an original parameter sent by the terminal, determine the original parameter corresponding to the request and send the original parameter to the terminal. Then, the terminal can reorganize the target information based on the original parameter and display the reorganized target information in the target interface. So that when a user enters the target interface according to a notification message, even if the target information notified by the notification message becomes invalid, the target information can still be restored and supplied to the user, so that the user experience is improved.

In one embodiment, the foregoing device may further include:
an invalidation cause determining module (not shown in FIG. 9), configured to determine an invalidation cause of the target information; and
an invalidation cause sending module (not shown in FIG. 9), configured to send the invalidation cause to the terminal.

In one embodiment, the foregoing device may further include:
a notification message sending module (not shown in FIG. 9), configured to send a notification message about the target information to the terminal before receiving the request for acquiring the original parameter from the terminal.

In one embodiment, the above notification message may include a message identifier of the target information;
the foregoing original parameter determining module 910 may include:
an acquisition request receiving unit (not shown in FIG. 9), configured to receive the request for acquiring the original parameter from the terminal, where the request includes at least the message identifier; and
an original parameter determining unit (not shown in FIG. 9), configured to determine the original parameter corresponding to the message identifier.

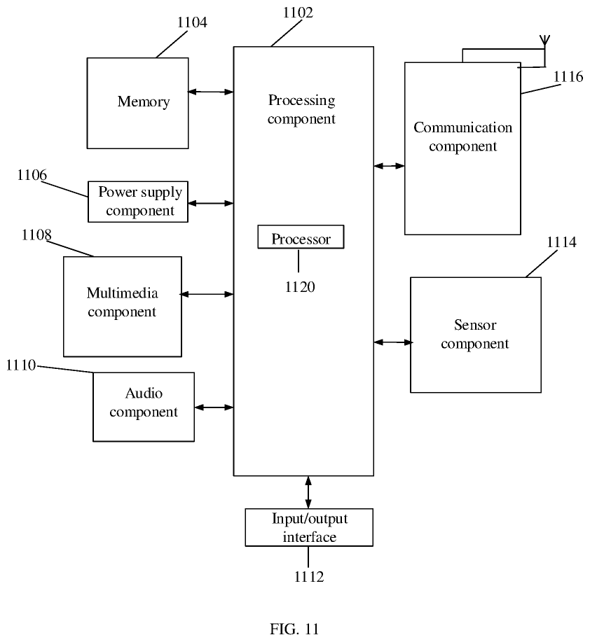

An embodiment of the present disclosure further provides a terminal. As shown in FIG. 10, the terminal may include a processor 1001, a communication interface 1002, a memory 1003 and a communication bus 1004, where the processor 1001, the communication interface 1002 and the memory 1003 communicate with one another through the communication bus 1004,
the memory 1003 is configured to store a computer program; and
the processor 1001 is configured to implement the steps of the first method for displaying information described in any of the foregoing embodiments when executing the program stored in the memory 1003.

Thus, the terminal can receive a triggering operation for a notification message, acquire current data of a target interface corresponding to the notification message and acquire original parameter of target information from a server to reorganize the target information and display the reorganized target information in the target interface when the current data does not include the target information notified by the notification message, so that when a user enters the target interface according to the notification message, even if the target information notified by the notification message becomes invalid, the target information can still be restored and supplied to the user, so that the user experience is improved.

The communication bus 1004 mentioned in the above terminal may be a peripheral component interconnect (PCI) bus or an extended industry standard architecture (EISA) bus or the like. The communication bus may include an address bus, a data bus, a control bus and so on. For ease of representation, only a thick line is adopted in the figure, but it does not mean that there is only one bus or one type of bus.

The communication interface 1002 is for communication between the aforementioned terminal and other equipment.

The memory 1003 may include a random access memory (RAM), and may also include a non-volatile memory (NVM), such as at least one disk memory. In some embodiments, the memory may also be at least one storage device far away from the foregoing processor 1001.

The aforementioned processor 1001 may be a general-purpose processor including a central processing unit (CPU), a network processor (NP) and the like; and the aforementioned processor may also be a digital signal processing (DSP), an application specific integrated circuit (ASIC), a field-programmable gate array (FPGA) or other programmable logic devices, discrete gates or transistor logic devices, or discrete hardware components.

FIG. 11 is a block diagram of a specific structure of the above terminal according to an exemplary embodiment. For example, the terminal may be a mobile phone, a computer, a digital broadcasting terminal, message receiving/sending equipment, a game console, tablet equipment, medical equipment, fitness equipment, a personal digital assistant and the like.

Referring to FIG. 11, the terminal may include one or more of the following components: a processing component 1102, a memory 1104, a power supply component 1106, a multimedia component 1108, an audio component 1110, an input/output (I/O) interface 1112, a sensor component 1114 and a communication component 1116.

The processing component 1102 generally controls overall operations of the terminal, such as operations associated with display, telephone calls, data communication, camera operations and recording operations. The processing component 1102 may include one or more processors 1120 to execute instructions to complete all or part of the steps of the foregoing methods. In addition, the processing component 1102 may include one or more modules to facilitate the interaction between the processing component 1102 and other components. For example, the processing component 1102 may include a multimedia module (not shown in FIG. 11) to facilitate the interaction between the multimedia component 1108 and the processing component 1102.

The memory 1104 is configured to store various types of data to support operations at the terminal. Examples of these data include instructions for any application or methods operated on the terminal, contact data, phone book data, messages, images and videos. The memory 1104 may be implemented by any type of volatile or non-volatile storage equipment or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 1106 provides power for various components of the terminal. The power supply component 1106 may include a power management system, one or more power supplies and other components for generating, managing and distributing power for the terminal.

The multimedia component 1108 includes a screen providing an output interface between the terminal and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide and gestures on the touch panel. The touch sensors can not only sense a boundary of a touch or slide action, but also detect the duration and pressure related to the touch or slide operation. In some embodiments, the multimedia component 1108 includes a front-facing camera and/or a rear-facing camera. When the terminal is in an operating mode, such as a shooting mode or a video mode, the front-facing camera and/or the rear-facing camera can receive external multimedia data. Each of the front-facing camera and the rear-facing camera may be a fixed optical lens system or has focal length and optical zooming capabilities.

The audio component 1110 is configured to output and/or input audio signals. For example, the audio component 1110 includes a microphone (MIC), and when the terminal is in an operating mode, such as a calling mode, a recording mode and a voice recognition mode, the microphone is configured to receive external audio signals. The received audio signals may be further stored in the memory 1104 or transmitted through the communication component 1116. In some embodiments, the audio component 1110 further includes a loudspeaker for outputting audio signals.

The I/O interface 1112 provides an interface between the processing component 1102 and a peripheral interface module. The peripheral interface module may be a keyboard, a click wheel, buttons and the like. These buttons may include but are not limited to: a home button, volume buttons, a start button and a locking button.

The sensor component 1114 includes one or more sensors and is configured to provide the terminal with various state assessments. For example, the sensor component 1114 can detect the on/off state of the terminal and the relative positioning of the components, for instance, the components are a display and a keypad of the terminal, the sensor component 1114 can also detect the position change of the terminal or a component of the terminal, the presence or absence of contact between the user and the terminal, the orientation or acceleration/deceleration of the terminal and temperature changes of the terminal. The sensor component 1114 may include a proximity sensor configured to detect the presence of nearby objects when there is no physical contact. The sensor component 1114 may also include a light sensor, such as a CMOS or CCD image sensor, for use in imaging application. In some embodiments, the sensor component 1114 may also include an acceleration sensor, a gyroscope sensor, a magnetic sensor, a pressure sensor or a temperature sensor.

The communication component 1116 is configured to facilitate wired or wireless communication between the terminal and other equipment. The terminal can access wireless networks based on communication standards, such as WiFi, service provider networks (such as 2G, 3G, 4G or 5G) or a combination thereof. In some embodiments, the communication component 1116 receives broadcast signals or broadcast related information from an external broadcast management system via a broadcast channel. In some embodiments, the communication component 1116 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In some embodiments, the terminal may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components to implement the above methods.

In some embodiments, a non-transitory computer-readable storage medium including instructions is further provided, such as the memory 1104 including instructions, the instructions may be executed by the processors 1120 of the terminal to complete the foregoing methods. For example, the non-transitory computer-readable storage medium may be an ROM, a random access memory (RAM), a CD-ROM, a magnetic tape, a floppy disk, optical data storage equipment and the like.

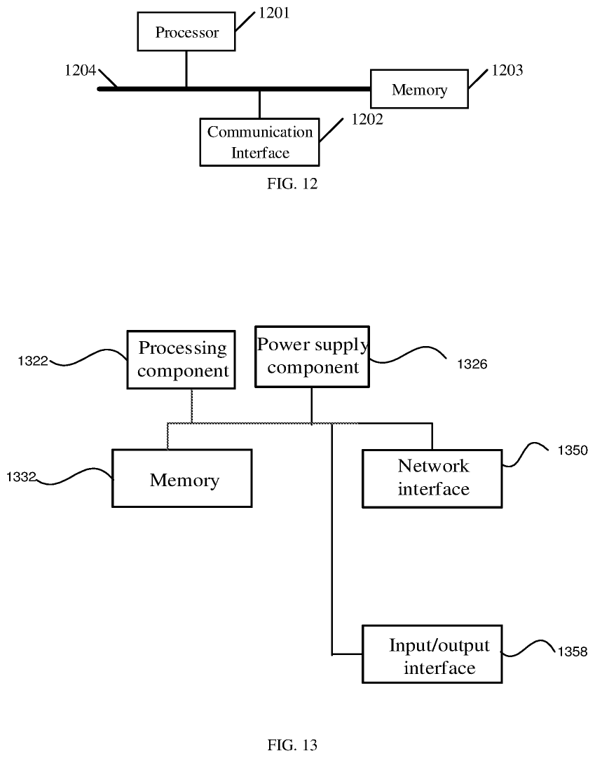

An embodiment of the present disclosure further provides a server. As shown in FIG. 12, the server may include a processor 1201, a communication interface 1202, a memory 1203 and a communication bus 1204, where the processor 1201, the communication interface 1202 and the memory 1203 communicate with one another through the communication bus 1204,
the memory 1203 is configured to store a computer program; and
the processor 1201 is configured to implement the steps of the second method for displaying information described in any of the foregoing embodiments when executing the program stored in the memory 1203.

Thus, the server can receive a request for acquiring an original parameter sent by a terminal, determine the original parameter corresponding to the request, and send the original parameter to the terminal. Then, the terminal can reorganize target information based on the original parameter and display the reorganized target information in a target interface. Thus, when a user enters the target interface according to a notification message, even if the target information notified by the notification message becomes invalid, the target information can still be restored and supplied to the user, so that the user experience is improved.

The communication bus 1204 mentioned by the above server may be a peripheral component interconnect (PCI) bus or an extended industry standard architecture (EISA) bus or the like. The communication bus may include an address bus, a data bus, a control bus and so on. For ease of representation, only a thick line is adopted in the figure, but it does not mean that there is only one bus or one type of bus.

The communication interface 1202 is for communication between the aforementioned server and other equipment.

The memory 1203 may include a random access memory (RAM), and may also include a non-volatile memory (NVM), such as at least one disk memory. In some embodiments, the memory may also be at least one storage device far away from the foregoing processor 1201.

The aforementioned processor 1201 may be a general-purpose processor including a central processing unit (CPU), a network processor (NP) and the like; and may also be a digital signal processor (DSP), an application specific integrated circuit (ASIC), a field-programmable gate array (FPGA) or other programmable logic devices, discrete gates or transistor logic devices, or discrete hardware components.

FIG. 13 is a block diagram of a specific structure of the foregoing server according to an exemplary embodiment. The server includes a processing component 1322 which further includes one or more processors, and a memory resource represented by a memory 1332 used for storing instructions which can be executed by the processing component 1322, such as application. The application stored in the memory 1332 may include one or more modules, where each module corresponds to a set of instructions. In addition, the processing component 1322 is configured to execute instructions to implement the aforementioned method for displaying information.

The server may also include a power supply component 1326 configured to perform power management of the server, a wired or wireless network interface 1350 configured to connect the server to the network, and an input/output (I/O) interface 1358. The server can be operated based on an operating system stored in the memory 1332, such as Windows Server™, Mac OS X™, Unix™, Linux™, FreeBSD™ or the like.

An embodiment of the present disclosure further provides a computer-readable storage medium. When instructions in the storage medium are executed by a processor of a terminal, the terminal can execute the first method for displaying information described in any of the above embodiments.

Thus, the terminal can receive a triggering operation for a notification message, acquire current data of a target interface corresponding to the notification message and acquire the original parameter of target information from a server to reorganize the target information and display the reorganized target information in the target interface when the current data does not include the target information notified by the notification message, so that when a user enters the target interface according to the notification message, even if the target information notified by the notification message becomes invalid, the target information can still be restored and supplied to the user, so that the user experience is improved.

An embodiment of the present disclosure further provides another computer-readable storage medium. When instructions in the storage medium are executed by a processor of a server, the server can execute the second method for displaying information described in any of the above embodiments.

Thus, the server can receive a request for acquiring an original parameter sent by a terminal, determine the original parameter corresponding to the request, and send the original parameter to the terminal. Then, the terminal can reorganize target information based on the original parameter and display the reorganized target information in a target interface. Thus, when a user enters the target interface according to a notification message, even if the target information notified by the notification message becomes invalid, the target information can still be restored and supplied to the user, so that the user experience is improved.

An embodiment of the present disclosure further provides an application product which is configured to implement the first method for displaying information described in any one of the foregoing embodiments at runtime.

Thus, when the application product is running, a terminal can receive a triggering operation for a notification message, acquire current data of a target interface corresponding to the notification message and acquire an original parameter of target information from a server to reorganize the target information and display the reorganized target information in the target interface when the current data does not include the target information notified by the notification message, so that when a user enters the target interface according to the notification message, even if the target information notified by the notification message becomes invalid, the target information can still be restored and supplied to the user, so that the user experience is improved.

An embodiment of the present disclosure further provides another application product which is configured to implement the second method for displaying information described in any one of the foregoing embodiments at runtime.

Thus, when the application product is running, a server can receive a request for acquiring an original parameter sent by a terminal, determine the original parameter corresponding to the request, and send the original parameter to the terminal. Then, the terminal can reorganize target information based on the original parameter and display the reorganized target information in a target interface. Thus, when a user enters the target interface according to a notification message, even if the target information notified by the notification message becomes invalid, the target information can still be restored and supplied to the user, so that the user experience is improved.

Those skilled in the art are likely to think of other embodiments of the present disclosure after considering the Description and practicing the application disclosed herein. The present disclosure is intended to cover any variations and use or adaptive changes of the present disclosure. These variations and use or adaptive changes follow the general principles of the present disclosure and include common knowledge or conventional technical means in the technical field which are not disclosed in the present disclosure. The Description and the embodiments are only to be regarded as exemplary, and the true scope and spirit of the present disclosure are indicated by the above claims.

It should be understood that the present disclosure is not limited to the precise structure described above and shown in the accompanying drawings, and various modifications and changes can be made without departing from the scope. The scope of the present disclosure is only limited by the appended claims.

What is claimed is:

1. A method for displaying information, applied to a terminal and comprising:
receiving a triggering operation for a notification message; wherein the notification message is for notifying target information with an invalidation condition, and the target information is no longer displayed after meeting the invalidation condition;
acquiring first data of a target interface corresponding to the notification message;
acquiring an original parameter of the target information from a server when the first data does not comprise the target information;
reorganizing the target information based on the original parameter; and
displaying the target information in the target interface.

2. The method of claim 1, wherein the original parameter comprises at least a source and content information of the target information; and
said reorganizing the target information based on the original parameter and displaying the target information in the target interface comprises:
determining a target display style corresponding to the target information according to the source, the content information and a preset corresponding relationship,
wherein the preset corresponding relationship is a corresponding relationship between the source and the content information and a preset display style; and
displaying the target information at a preset position in the target interface according to the target display style.

3. The method of claim 1, wherein the target interface is an interface for displaying multimedia data streams; and
said displaying the target information in the target interface comprises:
displaying the target information by inserting the target information into the multimedia data streams presented at the target interface.

4. The method of claim 1, wherein the method further comprises:
acquiring an invalidation cause of the target information; and
displaying prompt information corresponding to the invalidation cause in response to the triggering operation for the target information.

5. The method of claim 1, wherein the notification message comprises a message identifier of the target information; and
said acquiring the original parameter of the target information from the server comprises:
sending a request for acquiring the original parameter to the server, wherein the request comprises at least the message identifier; and
receiving the original parameter corresponding to the message identifier from the server.

6. A method for displaying information, applied to a server and comprising:
receiving a request for acquiring an original parameter from a terminal; wherein the terminal is configured to reorganize target information based on the original parameter, and display the target information in a target interface;
determining the original parameter corresponding to the request; and
sending the original parameter to the terminal.

7. The method of claim 6, wherein the method further comprises:
determining an invalidation cause of the target information; and
sending the invalidation cause to the terminal.

8. The method of claim 6, wherein before receiving the request for acquiring the original parameter from the terminal, the method further comprises:
sending a notification message about the target information to the terminal.

9. The method of claim 8, wherein the notification message comprises a message identifier of the target information; and
said receiving the request for acquiring the original parameter from the terminal, and determining the original parameter corresponding to the request comprises:
receiving the request for acquiring the original parameter from the terminal, wherein the request comprises at least the message identifier; and
determining the original parameter corresponding to the message identifier.

10. A terminal, comprising:
a processor; and
a memory for storing instructions, and the instructions enable the processor to execute the instructions;
wherein the processor is configured to execute the instructions to implement the method for displaying information of claim 1, and
wherein the method comprises:
receiving a triggering operation for a notification message; wherein the notification message is for notifying target information with an invalidation condition, and the target information is no longer displayed after meeting the invalidation condition;
acquiring first data of a target interface corresponding to the notification message;
acquiring an original parameter of the target information from a server when the first data does not comprise the target information;
reorganizing the target information based on the original parameter; and
displaying the target information in the target interface.

11. The terminal of claim 10, wherein the original parameter comprises at least a source and content information of the target information; and
the processor configured to reorganize the target information based on the original parameter and display the target information in the target interface, is further configured to:
determine a target display style corresponding to the target information according to the source, the content information and a preset corresponding relationship,
wherein the preset corresponding relationship is a corresponding relationship between the source and the content information and a preset display style; and
display the target information at a preset position in the target interface according to the target display style.

12. The terminal of claim 10, wherein the target interface is an interface for displaying multimedia data streams, and
the processor configured to display the target information in the target interface, is further configured to:
display the target information by inserting the target information into the multimedia data streams presented at the target interface.

13. The terminal of claim 10, wherein the processor is further configured to:
acquire an invalidation cause of the target information; and
display prompt information corresponding to the invalidation cause in response to the triggering operation for the target information.

14. The terminal of claim 10, wherein the notification message comprises a message identifier of the target information; and
the processor configured to acquire the original parameter of the target information from the server, is further configured to:
send a request for acquiring the original parameter to the server, wherein the request comprises at least the message identifier; and
receive the original parameter corresponding to the message identifier from the server.

15. A server, comprising:
a processor; and
a memory for storing instructions, and the instructions enable the processor to execute the instructions;
wherein the processor is configured to execute the instructions to implement the method for displaying information of claim 6; and
wherein the method comprises:
receiving a request for acquiring an original parameter from a terminal; wherein the terminal is configured to reorganize target information based on the original parameter, and display the target information in a target interface;
determining the original parameter corresponding to the request; and
sending the original parameter to the terminal.

16. The server of claim 15, the processor is further configured to:
determine an invalidation cause of the target information; and
send the invalidation cause to the terminal.

17. The server of claim 15, wherein before the server receives the request for acquiring the original parameter from the terminal, the processor is further configured to:
send a notification message about the target information to the terminal.

18. The server of claim 17, wherein the notification message comprises a message identifier of the target information; and
the processor configured to receive the request for acquiring the original parameter from the terminal, and determine the original parameter corresponding to the request, is further configured to:
receive the request for acquiring the original parameter from the terminal, wherein the request comprises at least the message identifier; and
determine the original parameter corresponding to the message identifier.

19. A system for displaying information, comprising:
a terminal, and a server;
wherein the terminal comprises a first processor, and a first memory for storing first instructions; and wherein the first instructions enable the first processor to execute the first instructions, and the first processor is configured to execute the first instructions to:
receive a triggering operation for a notification message; wherein the notification message is for notifying target information with an invalidation condition, and the target information is no longer displayed after meeting the invalidation condition;
acquire first data of a target interface corresponding to the notification message;
acquire an original parameter of the target information from the server when the first data does not comprise the target information;
reorganize the target information based on the original parameter; and
display the target information in the target interface;
wherein the server comprises a second processor, and a second memory for storing second instructions; the second processor is configured to execute the second instructions to:
receive a request for acquiring the original parameter from the terminal, and determine the original parameter corresponding to the request; and
send the original parameter to the terminal.

20. A storage medium, wherein when instructions in the storage medium are executed by a processor of electronic equipment, the electronic equipment implements the method for displaying information of claim 1.

21. A storage medium, wherein when instructions in the storage medium are executed by a processor of electronic equipment, the electronic equipment implements the method for displaying information of claim 6.
